(19) United States
(12) Patent Application Publication
(10) Pub. No.: US 2017/0003861 A1
(43) Pub. Date: Jan. 5, 2017

(54) COGNITIVELY AWARE SELECTABLE CONTROLS

(71) Applicant: International Business Machines Corporation, Armonk, NY (US)

(72) Inventors: Minkyong Kim, Scarsdale, NY (US); James R. Kozloski, New Fairfield, CT (US); Clifford A. Pickover, Yorktown Heights, NY (US); Maja Vukovic, New York, NY (US)

(21) Appl. No.: 14/788,245

(22) Filed: Jun. 30, 2015

(51) Int. Cl. G06F 3/0484; G06F 3/01

(52) U.S. Cl. CPC G06F 3/04847; G06F 3/015

(57) ABSTRACT

A method of operating a computer system using a cognitively aware control includes receiving an input to the cognitively aware control, wherein the cognitively aware control is associated with a first action, determining, by a user assessment module of the computer system, a cognitive state of a user of an application executed by the computer system and associated with the cognitively aware control, and selecting a second action in response to the input to the cognitively aware control and the cognitive state of the user, wherein the second action is performed by the computer system.

### BACKGROUND

The present disclosure relates to graphic user interfaces of computer systems, and more particularly to cognitively aware selectable controls.

A computer system typically provides a graphical user interface (GUI) as a means of interface. The GUI enables a user to interact with an application executing on the computer system through graphical elements (e.g., icons and visual indicators). These graphical elements can include controls or widgets, which the user can interact with to perform a task. Controls can take the forms of buttons, tabs, scroll bars, text boxes, drop-down menus and the like.

### BRIEF SUMMARY

According to an exemplary embodiment of the present invention, a method of operating a computer system using a cognitively aware control includes receiving, through an input device of the computer system, an input to the cognitively aware control, wherein the cognitively aware control is associated with a first action of the computer system, determining, by a user assessment module of the computer system, a cognitive state of a user of an application executed by the computer system and associated with the cognitively aware control, and selecting a second action in response to the input to the cognitively aware control and the cognitive state of the user, wherein the second action is performed by the computer system.

According to an exemplary embodiment of the present invention, a computer program product for operating a computer system using a cognitively aware control includes a computer readable storage medium having program instructions embodied therewith, the program instructions executable by a processor to cause the processor to retrieve data from a memory, the data defining a first action associated with the cognitively aware control of a graphical user interface, display the graphical user interface including the cognitively aware control, receive data corresponding to at least one interaction of a user with the cognitively aware control, determine, using at least one sensor, a cognitive state of the user, and select a second action in response to the interaction of the user with the cognitively aware control and the cognitive state of the user, wherein the second action is performed by the computer program product.

### BRIEF DESCRIPTION OF THE SEVERAL VIEWS OF THE DRAWINGS

Preferred embodiments of the present invention will be described below in more detail, with reference to the accompanying drawings:

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 depicts an exemplary cognitively aware control according to an exemplary embodiment of the present invention;

FIG. 5 depicts an exemplary cognitively aware control according to an exemplary embodiment of the present invention;

FIG. 6 is a diagram of computer system comprising modules configured to execute a cognitively aware control method according to an exemplary embodiment of the present invention; and

FIG. 7 is a diagram of a computer system configured to implement a cognitively aware control according to an exemplary embodiment of the present invention.

### DETAILED DESCRIPTION

According to an exemplary embodiment of the present invention, a computer system is configured having a graphical user interface (GUI) control responsive to a determination of a user's cognitive sate. In at least one embodiment, the GUI control exhibits a nuanced response and functionality based on the user's cognitive state. According to one or more embodiments of the present invention, the user's cognitive state is estimated based on one or more cognitive features of the user detected by the computer system.

As used in the present disclosure, a cognitive feature is a representation of measures of a user's total behavior over some period of time (including for example, musculoskeletal gestures, speech gestures, and internal physiological changes, measured by imaging devices, microphones, physiological and kinematic sensors in a high dimensional measurement space) within a lower dimensional feature space. In at least one embodiment feature extraction techniques are used for identifying certain cognitive features. Specifically, the reduction of a set of behavioral measures over some period of time to a set of feature nodes and vectors, corresponding to the behavioral measures' representations in the lower dimensional feature space, is used to identify the emergence of a certain cognitive features over that period of time. The relationship of one feature node to other similar nodes through edges in a graph corresponds to the temporal order of transitions from one set of measures and the feature nodes and vectors to another. Some connected subgraph of the feature nodes is herein defined as a cognitive feature. Described herein are the analysis, categorization, and identification of these cognitive features by means of further feature analysis of subgraphs, including dimensionality reduction of the subgraphs, for example by means of graphical analysis, which extracts topological features and categorizes the resultant subgraph and its associated feature nodes and edges within a subgraph feature space.

According to an exemplary embodiment of the present invention, the control, e.g., a selectable icon or button for controlling the computer system, is displayed as part of the GUI, wherein the computer system includes means for estimating the cognitive state of the user, and based on a user's interaction with the control and the cognitive state of the user, the computer system performs an action. This control is a cognitively aware control. In one or more embodiments of the present invention, the computer system offers a tip or help message to the user with respect to the selection of the cognitively aware control and the user's current cognitive state.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

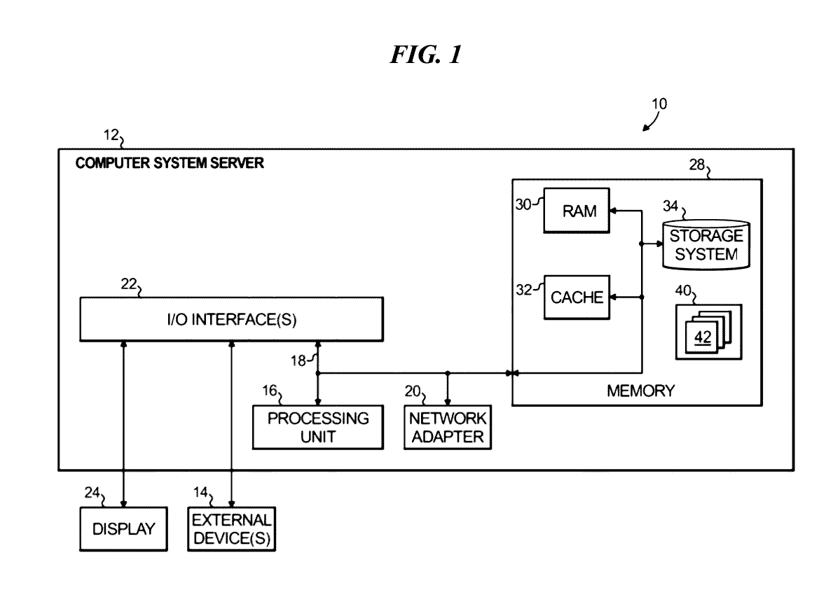

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

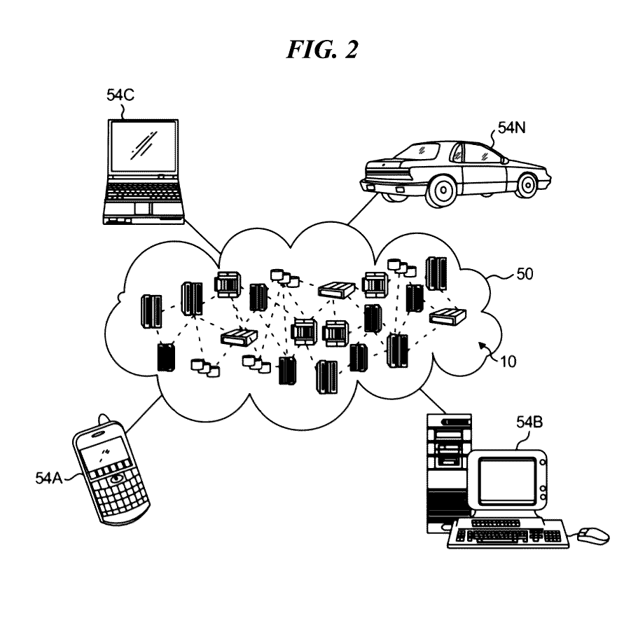

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

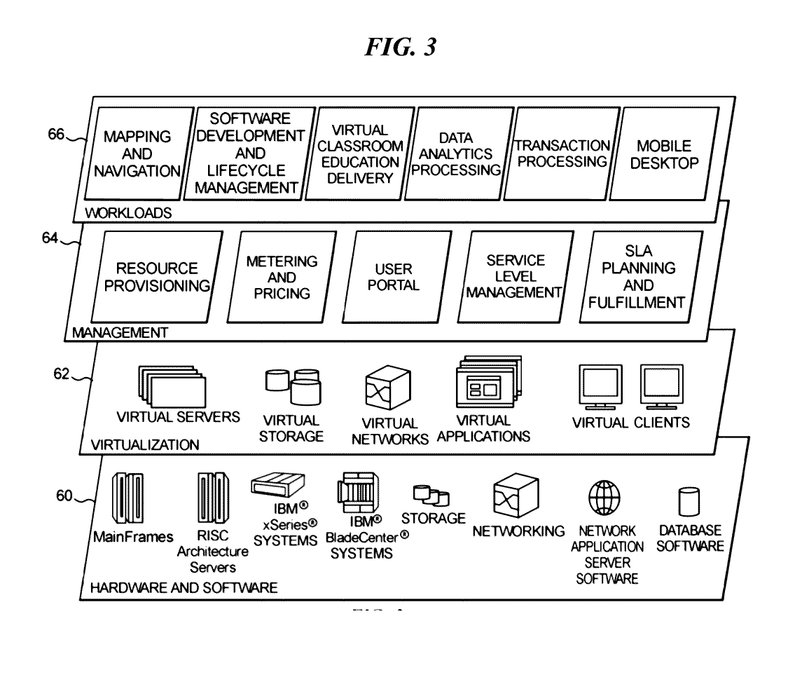

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and mobile desktop.

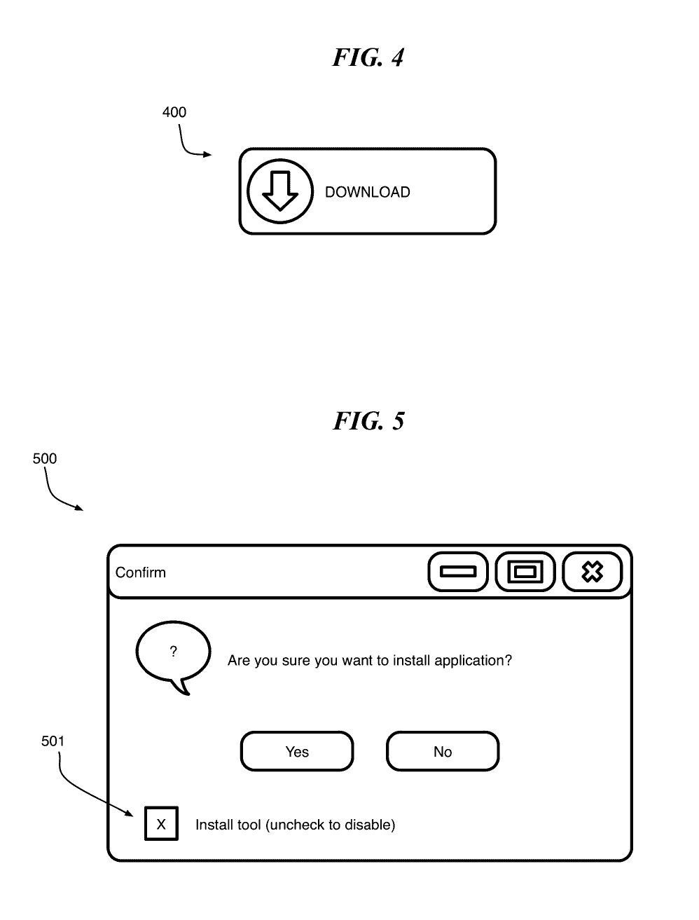

According to an exemplary embodiment of the present invention, in certain situations it can be difficult for a user to be confident, in advance, of the function associated with a GUI control. That is, the user may not be completely aware of the result(s) of a given interaction with the GUI control. The level of confidence or certainty that the user has can vary depending on one or more cognitive features affecting the user's cognitive state. These cognitive features can include an indication of context (e.g., what application to the GUI control associated with), the current time of day, a detected degree of distraction or fatigue, etc. In the execution of an application, the computer system may require that the user make a selection using a GUI control. In such a case, the user may be unsure of the potential risks and implications of the selection. According to an embodiment of the present invention, if the control (e.g., see 400, FIG. 4) is sensitive to a cognitive state of the user, any bias of the user at the moment of selection (e.g., due to a state of elation, nervousness, etc.) can be mitigated.

Embodiments of the present invention are applicable to a verity of scenarios. For example, in cases where the user is nervous about selecting a control button due to uncertainty about the result of this interaction. In another example, the user may be enthusiastic about exploring new features of an application. These different cognitive states of the user can be estimated based on observations about the user. According to an embodiment of the present invention, user biases that result from these different cognitive states can be mitigated.

According to one or more embodiments of the present invention, the computer system is configured to detect one or more cognitive features of the user, and estimate a current cognitive state of the user from the cognitive features. According to an exemplary embodiment of the present invention, the cognitive state can be estimated using one or more cognitive features including acoustic features, visual features, linguistic features, and physical features that are extracted from signals obtained by one or more sensors with a processor. The acoustic, visual, linguistic, and physical features are analyzed by one or more machine learning algorithms and a cognitive state of the user is extracted from analysis of the features.

Cognitive features can be detected based on direct observation of user interactions with the computer system (e.g., typing speed, cursors movements, etc.) and direct observations of the user (e.g., observed heart rate output by a wearable device communicating with the computer system, pupil dilation measured using a camera of the computer system, tonal variations in voice input to the computer system, etc.). According to an embodiment of the present invention, the cognitive state of the user is estimated using one or more cognitive features. In at least one embodiment, the cognitive state is estimated as an average of a plurality of weighted cognitive features, wherein cognitive features having high confidence levels have more weight than cognitive features with low confidence.

According to an exemplary embodiment of the present invention, the cognitive state of the user can be estimated to be distracted or nervous about selecting the control. In response to the interaction and the estimated cognitive state, the action associated with the control and performed by the computer system is modified, for example, delayed. In one or more embodiments of the present invention, assistance is requested or rendered in the form of a tip. The assistance can be provided by, for example, a digital assistant, a helpdesk, or a caregiver.

According to an exemplary embodiment of the present invention, a default action associated with the control is modified based on past cognitive states of the user and past interactions and effects with respect to the same or similar GUI control. These past interactions can be made available in a history of user activity stored in a database searchable by the system. In one exemplary implementation, the system determines a previous interaction in the history of user activity and infers a past cognitive sate from this interaction. Based on the inferred past cognitive state, the system can enter a verbose mode giving the user additional information about the operation being performed. In one example, the previous (negative) interaction is determined to be the installation of an unwanted application requiring a system restore to remove the application. Other indications of negative interactions include those that prompt the user to seek the advice of a help desk, steps that needed to be repeating more than once, etc. Similarly, in at least one embodiment, the system reacts to previous positive interactions to, for example, streamline a current operation based on an inference of user confidence (e.g., the current cognitive state). According to an exemplary embodiment of the present invention, the previous interactions can be considered during a current interaction with a cognitively aware control.

According to an exemplary embodiment of the present invention, the cognitively aware control is associated with a controllable action. In one or more embodiments, the controllable action has a default action and one or more variations, which are selectable depending on the cognitive state of the user. In another example, the controllable action is associated with one or more delay times, or a variable delay time, selectable depending on the cognitive state of the user. In yet another example, the controllable action is associated with a repeat function, wherein the action is repeatable one or more times depending on the cognitive state of the user. In another example, the controllable action includes a parallel signal (e.g., a request for service) sent to a third party.

In still another example, the controllable action is associated with one or more tips about the functionality of the application. According to an exemplary embodiment of the present invention, the tip output by the system varies based on the cognitive state of the user, or on one or more cognitive features of the user. For example, in a case where the system detects that the user is nervous, distracted, and/or hesitant through an analysis of facial expressions and gaze, the system is configured to assure the user through a spoken or textual message. In another example, the system is configured to suggest that the user defer the selection, seek additional assistance, take a protective step (e.g., backing up a file or increasing font size for easier reading of instructions), etc.

According to an exemplary embodiment of the present invention, and in one or more of the above examples, the application executing on the computer system apprises the user of certain risks of making a selection based on the assessment of the cognitive state of the user.

According to an exemplary embodiment of the present invention, the cognitive state can includes a measure of anxiety, elation, hesitance, confusion, fatigue, annoyance, and emotional nihilism. The cognitive feature may be measured in real time, e.g. through a biometric, a sensing of user pressure applied to a touch screen, etc.

According to an exemplary embodiment of the present invention, a history of user actions is analyzed, wherein certain estimated cognitive states may grow in likelihood as additional evidence of them is identified in user behaviors and measures. According to an exemplary embodiment of the present invention, cognitive state evolution is estimated with techniques such as parameter estimation of random Markov process, Bayesian inference, etc.

Typically, the user selects a control button from the GUI, which triggers a particular action, e.g., Action 1. According to an exemplary embodiment of the present invention, the cognitively aware control also receives input on a user's cognitive state, and triggers a second action, e.g., Action 2 (e.g., see 500, FIG. 5, wherein a window is displayed asking the user to confirm installation of an application). Action 2 may also include a delay of the action, a repeat of the action, a parallel signal sent to a third party, etc. The cognitive button can also trigger tips regarding a planned action to be triggered. In at least one example, Action 1 is delayed until an outcome of Action 2 is determined. For example, the user may agree to installing certain software (i.e., Action 1), but the action may not be completed until the action is reviewed, e.g., by a digital assistant, a helpdesk, or a caregiver and agreed to (Action 2). For example, consider the case of a user selecting a GUI element for installing an animation application 500. The user is nervous, hesitant, distracted, etc., as estimated by an analysis of the user's face. An assistant is alerted, and the assistant notices that a box 501 in the GUI can be unchecked so that the inadvertent installation of unneeded or malicious software is not performed. The assistant can uncheck the box 501. The system continues, downloading and installing the animation application. In view of the forgoing the system improves the functioning of the computer using cognitively aware controls.

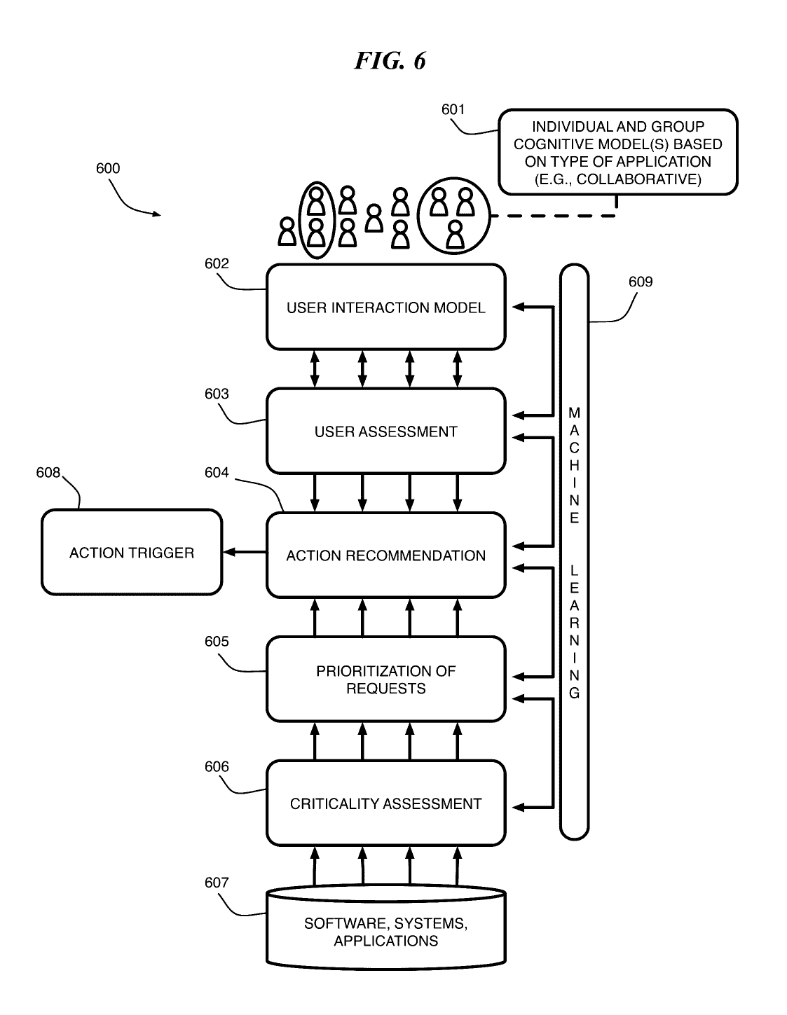

Referring to FIG. 6, according to at least one embodiment of the present invention, a computer system 600 comprises user interaction model 602, a user assessment module 603, an action recommendation module 604, a prioritization module 605, a criticality assessment module 606, a database 607, an action trigger module 608 and a machine learning module 609. The computer system 600 further includes an individual and group cognitive module 601 for a particular application.

In at least one embodiment of the present invention, the user interaction model 602 is stored in a tangible database accessible by the computer system.

According to an embodiment of the present invention, the user assessment module 603 comprises one or more sensors, such as a camera configured to capture an image of the user, a communications interface to one or more external sensors (e.g., a heart rate monitor), and an application monitoring user interactions with the computer (e.g., a monitor of user interactions configured to determine whether the user is hesitate about an input). Each of the sensors is configured to determine one or more cognitive features of the user. The user assessment module 603 estimates the cognitive state of the user based on the determined cognitive features.

The action recommendation module 604 of the computer system uses a default action of the cognitively aware control and the cognitive state of the user as determined by the user assessment module 603 to recommend an action. For example, the action recommendation module 604 can recommend a second action delaying the default action of the cognitively aware control. The action recommendation module 604 also receives an indication of the priority of a request or user interaction.

According to an embodiment of the present invention, user interactions are assessed for criticality and prioritized. The criticality assessment module 606 determines a risk of a current user interaction with the computer system 600, and more particularly, with the software, systems and applications comprising the computer system 600. The determined risk is input into the prioritization module 605 which prioritizes the user input with other operations of the computer system.

According to at least one embodiment of the present invention, the criticality assessment module 606 determines, with a certain confidence level, that an action is associated with a risk (e.g., the action will be deleterious to the user, the computer system, or both). For example, a user may use a certain combination of keys on a keyboard while using a word processor that are known to the system, e.g., from past use, to lead to a confusing state (e.g., opening an unexpected window) or a destructive state (e.g., losing data copied to a clipboard) in the document being edited, particular when the user has a nervous or distracted cognitive state. In another example, installing a piece of software from a pop-up menu is known to download an unrelated piece of software that tends to be unwanted or impacts system performance. In this case, the criticality assessment module 606 determines that these operations are associated with a risk and the prioritization module 605 is used to prioritize the user input relative to many possible operations taking place on a computer and thus quickly interrupt a current process, delay a next process, issue a warning, etc.

According to at least one embodiment of the present invention, if a user (or cohort of users with similar cognitive states or features) has experienced a problem in the past as a result of performing a same or similar action, this may be used to help determine risk. For example, if the user, or cohort of users, has caused the problem by performing the action in the past, the risk associated with the action is increased. Similarly, the confidence level associated with the determined risk can be increased for future invocations of the action.

According to one or more embodiments of the present invention, the computer system 600 includes a machine learning module 608, which tailors the cognitively aware control to the user or a group of users based on, for example, the cognitive features of the user, the risk of a current user interaction, a result of previous user interactions, etc.

According to an embodiment of the present invention, the computer system 600 includes an action trigger 608, which executes one or more instructions given an action recommendation. The action trigger 608 can, for example, trigger a warning message, send an alert to a caregiver, offer advice, etc.

According to one or more embodiments of the present invention, the cognitively aware control (e.g., GUI button) moves within the GUI based on a category of the cognitively aware control or context dependent data, along with cognitive state of the user. For example, a GUI window having a graphical slider or download button migrates within the desktop environment. More particularly, the window including the graphical slider moves toward the user's cursor or a focal point (e.g., determined using an eye tracker application and camera) upon determining that the GUI element is low risk and moves away from the cursor or focal point upon determining a high risk based on a user's cognitive state. In this case the speed of the movement of the window is less than the speed of the cursor (e.g., 50% of the speed of the cursor), such that the cursor catches up to the window even in the case where the window moves away from the cursor.

According to an exemplary embodiment of the present invention, the size, shape, and position of user interface elements are adjusted based on the cognitive state and user inputs to the cognitively aware control. Adjustments can reduce the cognitive load associated with selecting some user interface elements. Historical usage data can originate from one or more users and one or devices. Embodiments of the present invention are applicable to single users, and also to broader assessments of groups of users, including specific cohorts (e.g., such as residents of nursing homes, students in elementary school, etc.)

According to an exemplary embodiment of the present invention, when the cognitively aware control is associated with some advice provided based on an estimate of the user's cognitive state, adjustment limits are used to ensure that the GUI remains appropriately usable, such that the GUI can influence user interactions. In one example, the system tracks, in a user controlled fashion, interactions of a group of users with an application. If a threshold number of users encounter the same or similar problem with the application, then an action (e.g., contacting an assistant, providing additional alerts to the user, etc.) is performed with greater confidence.

In a case that the user desires to enable cognitive feature input, the computer system having a multi-functional input interfaces, is configured to interact with the GUI. The computer system is configured to provide improved accessibility, coupled with the estimates of cognitive state, to the user. The computer system may be configured to assist users having limited computing knowledge and/or skills, limited physical and/or cognitive abilities, etc.

It should be understood that the cognitively aware control relays user inputs to an underlying application, such as an operating system. As such, the cognitively aware control can be used to access services, applications, and content.

According to an exemplary embodiment of the present invention, the computer system includes an observing module facilitating inferencing user emotional and personality states from the user behavior observed.

According to an exemplary embodiment of the present invention, the computer system considers the current cognitive state of the user, and the resulting cognitive states the user or other users who have taken an action for the given cognitively aware control in the past. Based on the history of the users' satisfaction or the resulting state of machines after taking the given action (e.g., choosing Yes versus No for software update), the cognitively aware control provides details about the expected resulting state (e.g., including the user's cognitive state or computer system's state) to offer an improved selection.

According to an exemplary embodiment of the present invention, the computer system learns about user interactions with it, and a weight or criticality level of the work/software opened, thus facilitating decisions about the GUI cognitively aware control.

According to one or more exemplary embodiments of the present invention, certain autonomic functions of the computer system are triggered using a cognitively aware control. For example, a fatigued user who is making changes to the operating system, deleting files, or accepting installation of certain software packages offered via email, may trigger additional operating system actions such as automatic backups, preservation of system state for subsequent “roll back,” etc. In this case, the Action 2 taken in response to the Action 1 associated with the cognitively aware control and an assessment of the user's cognitive state is automatic and includes system/data self-preservation actions in the face of a temporarily incapacitated /degraded user cognitive function.

According to one or more exemplary embodiments of the present invention, a database collects information about specific user interactions (including actions and outcomes) in terms of system security, infection, or malware installation. In this way, a provider of system security services can compare every user action to the user database, and assign a level of risk associated with the action given the user's cognitive state, and outcomes that have occurred for other users presenting this cognitive state and taking a current action. As a result, the computer system is enabled with dynamic security levels, given the current cognitive state, and appropriate mitigation actions are deployed accordingly. In a particular example, given a context where the risk for malware contamination by a cohort of users (or a particular user) having a certain cognitive state is high, a security feature is enhanced and/or a response of a GUI element is adjusted. For example, the GUI element may have a default setting to perform action 1 (e.g., the download of software), but in these said high-risk contexts, the GUI elements triggers action 2 (e.g., requesting assistance, backup a system, delay action 1, etc.). Action 2 can take the form of a tip or suggested output to the user (e.g., to confirm action 1 after some period of time).

Furthermore, the cognitively aware control may indicate to the user some feature of a current possible cognitive state (e.g., fatigue, distraction level) during the act of selecting a GUI element, thereby providing additional versatility for controls. This indication may be through color, size, sound, and other modalities, and may be triggered when the user selects the cognitively aware control or prior to selection.

Applications of one or more embodiments of the present invention extend to selectable elements in 3D games and virtual worlds, and thus it is not restricted for use on a traditional 2D computer GUI.

By way of recapitulation, according to an exemplary embodiment of the present invention, a computer program product operates a computer system using a cognitively aware control, the computer program product comprising a computer readable storage medium having program instructions embodied therewith, the program instructions executable by a processor to cause the processor to retrieve data from a memory, the data defining a first action associated with the cognitively aware control of a graphical user interface, display the graphical user interface, receive data corresponding to at least one interaction of a user with the cognitively aware control, determine a cognitive state of the user; and select a second action in response to the interaction of the user with the cognitively aware control and the cognitive state of the user, wherein the second action is performed by the computer program product in connection with performing the first action.

The methodologies of embodiments of the disclosure may be particularly well-suited for use in an electronic device or alternative system. Accordingly, embodiments of the present invention may take the form of an entirely hardware embodiment or an embodiment combining software and hardware aspects that may all generally be referred to herein as a “processor,” “circuit,” “module” or “system.”

Furthermore, it should be noted that any of the methods described herein can include an additional step of providing a system (e.g., 600, FIG. 6) including user interaction model 602, a user assessment module 603, an action recommendation module 604, a prioritization module 605, a criticality assessment module 606, a database 607, an action trigger module 608 and a machine learning module 609. The system further includes an individual and group cognitive module 601 for a particular application. Further, a computer program product can include a tangible computer-readable recordable storage medium with code adapted to be executed to carry out one or more method steps described herein, including the provision of the system with the distinct software modules.

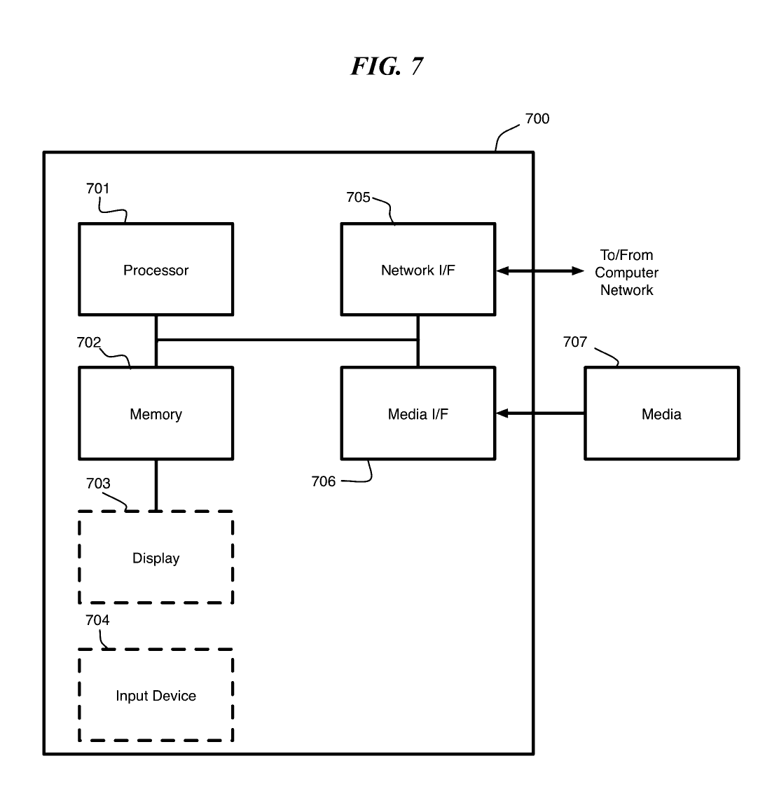

Referring to FIG. 7; FIG. 7 is a block diagram depicting an exemplary computer system having an interface including cognitively aware controls according to an embodiment of the present invention. The computer system shown in FIG. 7 includes a processor 701, memory 702, display 703, input device 704 (e.g., keyboard), a network interface (I/F) 705, a media I/F 706, and media 707, such as a signal source, e.g., camera, Hard Drive (HD), external memory device, etc.

In different applications, some of the components shown in FIG. 7 can be omitted. The whole system shown in FIG. 7 is controlled by computer readable instructions, which are generally stored in the media 707. The software can be downloaded from a network (not shown in the figures), stored in the media 707. Alternatively, software downloaded from a network can be loaded into the memory 702 and executed by the processor 701 so as to complete the function determined by the software.

The processor 701 may be configured to perform one or more methodologies described in the present disclosure, illustrative embodiments of which are shown in the above figures and described herein. Embodiments of the present invention can be implemented as a routine that is stored in memory 702 and executed by the processor 701 to process the signal from the media 707. As such, the computer system is a general-purpose computer system that becomes a specific purpose computer system when executing routines of the present disclosure.

Although the computer system described in FIG. 7 can support methods according to the present disclosure, this system is only one example of a computer system. Those skilled of the art should understand that other computer system designs can be used to implement embodiments of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of operating a computer system using a cognitively aware control, the method comprising:
receiving, through an input device of the computer system, an input to the cognitively aware control, wherein the cognitively aware control is associated with a first action of the computer system;
determining, by a user assessment module of the computer system, a cognitive state of a user of an application executed by the computer system and associated with the cognitively aware control; and
selecting a second action in response to the input to the cognitively aware control and the cognitive state of the user, wherein the second action is performed by the computer system.

2. The method of claim 1, wherein the second action is a modified version of the first action.

3. The method of claim 1, further comprising performing the first action by the computer system, wherein the second action delays the first action.

4. The method of claim 1, further comprising performing the first action by the computer system, wherein the second action is a repetition of the first action.

5. The method of claim 1, further comprising performing the first action by the computer system, wherein the first action and the second action comprise sending parallel signals to a target.

6. The method of claim 1, wherein the second action comprises outputting, via a graphical user interface of the computer system, information about the first action.

7. The method of claim 1, wherein determining the cognitive state comprises at least one of measuring characteristics of user input into the computer system and measuring physical characteristics of the user.

8. The method of claim 1, further comprising determining the cognitive state in real time.

9. The method of claim 8, wherein the determining the cognitive state comprises measuring a cognitive feature of the user through at least one of a biometric sensor and a touch sensor, the method further comprising comparing the measurement to a historic measurement of the cognitive feature.

10. The method of claim 1, wherein the cognitive state is determined based on at least one cognitive feature of the user, the method further comprising extracting the at least one cognitive feature using a sensor from as at least one of an acoustic feature, a visual feature, a linguistic feature, a behavioral feature, and a physical feature.

11. The method of claim 1, further comprising prioritizing an execution of a plurality of actions by the computer system, including the second action, based on the cognitive state.

12. The method of claim 1, further comprising storing, by the computer system, historical data in a database, the historical data comprising a plurality of cognitive states and/or machine states taken after performing a plurality of respective actions.

13. The method of claim 1, further comprising outputting, by a graphical user interface of the computer system, an indication of a cognitive feature of the cognitive state determined during a selection for the cognitively aware control.

14. A computer program product for operating a computer system using a cognitively aware control, the computer program product comprising a computer readable storage medium having program instructions embodied therewith, the program instructions executable by a processor to cause the processor to:
retrieve data from a memory, the data defining a first action associated with the cognitively aware control of a graphical user interface;
display the graphical user interface including the cognitively aware control;
receive data corresponding to at least one interaction of a user with the cognitively aware control;
determine, using at least one sensor, a cognitive state of the user; and
select a second action in response to the interaction of the user with the cognitively aware control and the cognitive state of the user, wherein the second action is performed by the computer program product.

15. The computer program product of claim 14, the program instructions executable by the processor to cause the processor to:
measure at least one cognitive feature of the user through at least one of a biometric sensor and a touch sensor, wherein the cognitive state is determined using the at least one cognitive feature; and
compare a measurement of the at least one cognitive feature to a historic measurement of the at least one cognitive feature.

16. The computer program product of claim 14, wherein the cognitive state is determined based on at least one cognitive feature of the user and wherein the program instructions executable by the processor to:
cause the processor to extract the at least one cognitive feature using a sensor from as at least one of an acoustic feature, a visual feature, a linguistic feature, a behavioral feature, and a physical feature.

17. The computer program product of claim 14, the program instructions executable by the processor to cause the processor to:
prioritize an execution of a plurality of actions, including the second action, based on the cognitive state.

18. The computer program product of claim 14, the program instructions executable by the processor to cause the processor to:
store historical data in a database, the historical data comprising a plurality of cognitive states and/or machine states taken after performing a plurality of respective actions.

19. The computer program product of claim 14, the program instructions executable by the processor to cause the processor to:
output, by the graphical user interface, an indication of a cognitive feature of the cognitive state determined during a selection for the cognitively aware control.
